(19) United States
(12) Patent Application Publication
(10) Pub. No.: US 2004/0006640 A1
(43) Pub. Date: Jan. 8, 2004

(54) Notification to routing protocols of changes to routing information base

(76) Inventors: Daniel W. Inderieden, Bloomington, MN (US); Andrew J. Lehtola, Coon Rapids, MN (US); Phillip A. Laverdiere, Shoreview, MN (US); Eric R. Lund, Lakeville, MN (US); Eric M. Berge, Apple Valley, MN (US); Scott E. Hauck, Bloomington, MN (US)

Correspondence Address: David D. Brush, WESTMAN CHAMPLIN & KELLY, International Centre, 900 South Second Avenue, Suite 1600, Minneapolis, MN, 55402-3319, US

(21) Appl. No.: 10/190,296

(22) Filed: Jul. 3, 2002

(51) Int. Cl. G06F 15/173

(52) U.S. Cl. 709/242

(57) ABSTRACT

A method and apparatus are provided for managing a routing information base that is adapted to store information regarding potential data routes within an internetworking device operating in conjunction with a plurality of routing protocols. Potential routes for a specified destination are stored in the routing information base. The routing protocols are notified of changes to only those routes for which the routing protocols have previously registered for notification.

### BACKGROUND

1. Technical Field

The present invention relates to an internetwork. More particularly, the present invention relates to an internetwork router which notifies routing protocols of changes to a routing information base.

2.Background of the Present Invention

Routers route information or data across an internetwork from a source to a destination. An internetwork is a collection of individual or autonomous networks that functions as a single large network. A single data message that is to be delivered from a source to a destination by a router is typically broken up into small packages, called packets. Each of the packets includes information on the sender's address, the receiver's address, the position of the packet in the message, and information that can be used to determine whether all of the packets have reached the destination.

Routing generally involves two basic activities: determination of optimal routing paths and the transport of packets through the internetwork. Although the transport of packets through an internetwork is relatively straight-forward, path determination can be very complex. Routing protocols are used to address the task of path determination. Using a routing algorithm, a routing protocol determines the optimal route for a given IP (Internet Protocol) destination according to the routing algorithm employed.

With routers becoming increasingly important in ensuring communication across internetworks, reliability is becoming an increasingly important characteristic for routers to have. In particular, with routers making up the “backbone” of large internetworks—those segments positioned at major traffic points on an internetwork—and routing millions of data packets every second and efficiently configuring these internetworks, routers must become more reliable than they currently are in order to ensure that such services are consistently available to the internetwork. For example, if one of these “core” routers were to fail, large regions of the internetwork could be affected. Consequently, it is desirable to have routers be more reliable as well as more robust to ensure that such capacity is consistently available.

Multi-protocol routing architectures increase the scalability, efficiency and reliability of a routing system by providing a plurality of different routing protocols, each of which provide candidate routes to a centralized routing information base (RIB). A RIB manager then selects the route that is to be actively employed for a given end destination and installs that active (“best”) route into a forwarding engine. When a new route is provided to the RIB by one of the routing protocols, the RIB manager considers anew which route should be made active, taking the newly added route into account. This process is sometimes referred to as “active route selection.” In conventional multi-protocol routing architectures, the RIB is a central shared resource for the protocols to use to store all of their candidate routes and all of the per-protocol attributes for each respective route. Such a system is inefficient and unreliable as a very large number of routes must be maintained in the central RIB, and if the central RIB goes down, all of the protocols are effected.

Certain routing protocols, such as the Border Gateway Protocol (BGP), for example, need to know what route is active for a given end destination. For this reason, prior art RIB management systems provide the BGP with every route change that is made to the RIB. Many of these changes have no bearing on the BGP. Therefore, forwarding every route change is an inefficient use of resources. Improved methods and apparatus are therefore desired for notifying protocols of route change information.

### SUMMARY OF THE INVENTION

One embodiment of the present invention is directed to a method of managing a routing information base adapted to store information regarding potential data routes within an internetworking device operating in conjunction with a plurality of routing protocols. The method includes: (a) storing a route to be employed for a specified destination in the routing information base; and (b) notifying a first routing protocol if a change is made to the route stored in the routing information base if the first routing protocol has registered to be notified of a change to that route.

Another embodiment of the present invention is directed to an internetworking device, which is adapted to operate in conjunction with a plurality of routing protocols, including a first routing protocol. The internetworking device includes a routing information base for storing a plurality of routes to a plurality of specified destinations, including a first route to a first destination. A routing information base manager is coupled to the routing information base and is adapted to notify the first routing protocol if a change is made to the first route if the first routing protocol has registered with the routing information base manager for notification of changes to the first route.

Another embodiment of the present invention is directed to a computer-readable medium having instructions stored thereon, which when executed by a processor of an internetworking device perform the following steps: (a) storing a route to be employed for a specified destination in the routing information base; and (b) notifying a first routing protocol if a change is made to the route stored in the routing information base if the first routing protocol has registered to be notified of a change to that route.

Yet another embodiment of the present invention is directed to a method for managing a routing information base, which is adapted to store information regarding potential data routes in conjunction with a plurality of routing protocols, including a border gateway protocol (BGP). The method includes the steps of: (a) storing a BGP route for a specified destination in the routing information base, wherein the BGP route has either an active state or an inactive state; and (b) notifying the BGP of a change to the BGP route if the change results in the BGP route switching between the active and inactive states and withholding notification of the BGP if the change results in the BGP route remaining in the inactive state.

### BRIEF DESCRIPTION OF THE DRAWINGS

FIG. 1 is a simplified block diagram of an internetwork router in accordance with one embodiment of the invention.

FIG. 2 is a block diagram depicting a dynamic routing system according to an illustrative embodiment of the present invention.

FIG. 3 is a block diagram depicting the function of a routing information base manager according to an illustrative embodiment of the present invention.

FIG. 4 is a block diagram depicting the flow of information for notification of the BGP protocol of a change to an active BGP route according to one embodiment of the present invention.

FIG. 5 is a block diagram depicting the flow of information for routing protocols to register for notification of changes to routes stored in the routing information base.

FIG. 6 is a flow chart illustrating a process in which a route lookup sub-component handles a registration request from a protocol according to one embodiment of the present invention.

FIG. 7 is a block diagram depicting the flow of information according to an illustrative implementation of a route redistribution feature of the present invention.

### DETAILED DESCRIPTION OF EMBODIMENTS OF THE PRESENT INVENTION

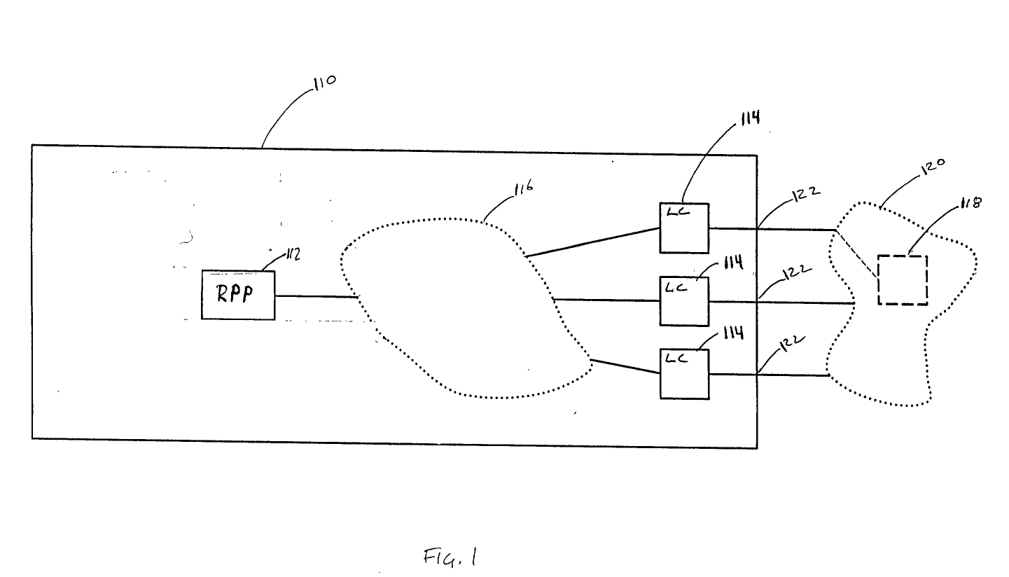

Embodiments of the present invention are now described with reference to the figures where like reference numbers indicate identical or functionally similar elements. FIG. 1 is a simplified block diagram of an internetwork router 110 in accordance with one embodiment of the invention. Router 110 generally includes one or more routing protocol processors (RPP) 112, a plurality of line cards 114, and an interconnection network 116. Although only three line cards 114 are shown in order to simplify the figure, any number of line cards can be used. RPP 112 includes routing components that are adapted to implement selected routing protocols to route data packets to, and receive data packets from, a peer network component (peer) 118 located in external switch network 120 and connected to internetwork router 110. Peer 118 can be, for example, a peer router or other network component. Individual line cards 114 receive incoming packets at respective ports 122 and deliver the incoming packets to RPP 112 as designated by information contained in the packets. Similarly, line cards 114 transfer packets received from RPP 112 to an appropriate destination, such as peer network component 118, through respective ports 122 as designated by information contained in the packets.

Interconnection network 116 is generally adapted to establish communication links between RPP 112 and line cards 114. Line cards 114 handle the forwarding of data packets. In one embodiment, line cards 114 include a forwarding information base (FIB) that stores information indicating the route that is to be employed to forward data packets to each of a plurality of IP destinations. Alternatively the forwarding information base can reside in RPP 112, which provides the forwarding information to line cards 114. The forwarding information stored in the forwarding information base is determined by a routing information base (RIB) manager with reference to a plurality of routing protocols as will be described below. The RIB manager, in turn, provides the forwarding information to the forwarding information base.

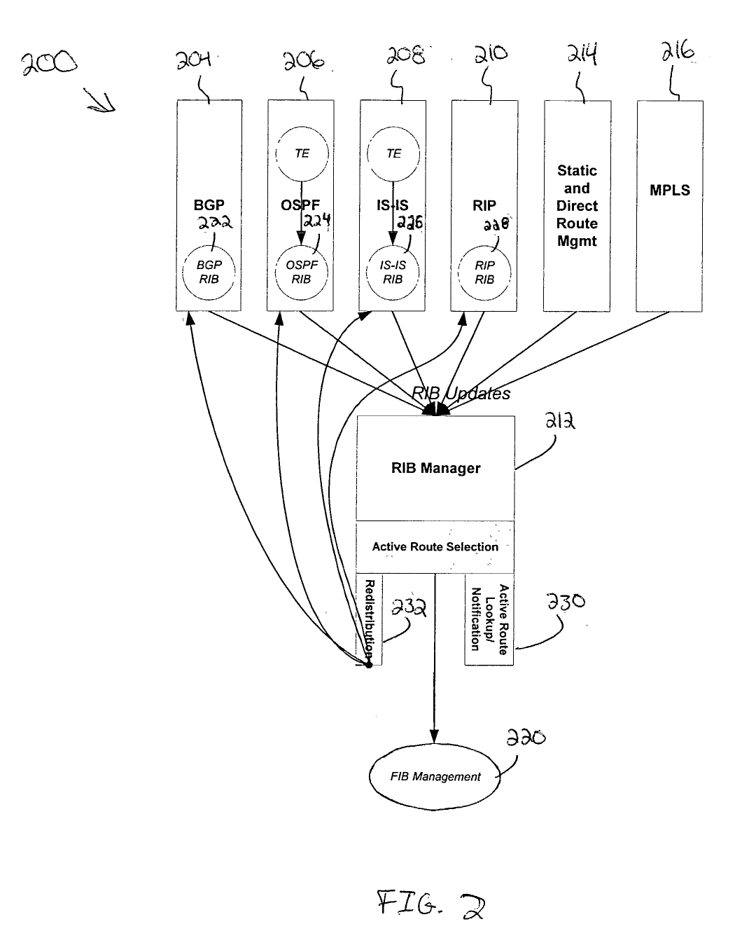

FIG. 2 is a block diagram depicting a dynamic routing (DR) system 200 according to an illustrative embodiment of the present invention. DR system 200 resides in routing protocol processor 112. According to one embodiment of the present invention, the routing architecture of DR system 200 accommodates a plurality of routing protocols. In the illustrative embodiment depicted in FIG. 2, these protocols include the following unicast routing protocols: Border Gateway Protocol (BGP) 204, Open Shortest Path First (OSPF) protocol 206, Intermediate System to Intermediate System (IS-IS) protocol 208 and Routing Information Protocol (RIP) 210. DR system 200 further includes RIB manager 212 and forwarding information base manager 220.

The routing information base (RIB) manager 212 receives routes from the unicast protocols, chooses the routes to be used for forwarding, and communicates routes between protocols. In one embodiment, the RIB manager 212 includes a routing information base (RIB), which is a table that stores the routes received from the routing protocols, together with various information concerning these routes. It will be appreciated that the RIB and the RIB manager 212 may also exist as separate entities in accordance with alternative embodiments of the present invention. Static and direct route manger 214 receives static and direct routes (routes to local interfaces) and stores these in the RIB. Multi-protocol label switching (MPLS) subsystem 216 adds tunnel ingress routes to the RIB. Redistribution element 232 sends route information to routing protocols 204, 206, 208 and 210 regarding routes to be redistributed from one routing protocol to another, as will be discussed in more detail subsequently.

To illustrate how these elements operate, a discussion of a flow traversing through FIG. 2 will now be discussed. In particular, the primary flow through FIG. 2 is as follows: The protocols (BGP 204, IS-IS 208, OSPF 206) communicate with their peers at other nodes throughout the internetwork and determine the routes that can be used for reaching a given IP destination. The peers of a given protocol are instances of that same protocol that are located at other network nodes. For IS-IS protocol 208 and OSPF protocol 206, members of a peer group share identical topological databases and exchange full link state information with each other. BGP protocol 204 is a distance vector protocol, in which members of a peer group share paths to destinations and attributes of these paths. Each protocol adds routes to the central RIB by sending them to the RIB Manager 212. The protocols that provide traffic engineering (TE) based weighting (e.g., OSPF 106, IS-IS 108), further provide multiple alternative routes for the same IP destination. The RIB manager 212 utilizes this information to determine which routes should be actively used to forward packets to the various IP destinations. This determination is sometimes referred to as active route selection. According to an embodiment of the present invention, the RIB manager 212 redistributes the active routes, according to a predetermined policy, to the various protocols, as will be described in detail below. The RIB Manager 212 also adds the active routes to the forwarding information base (FIB) 220, which stores the routes that are to be used to forward packets.

The above description illustrates some of the aspects of the unicast routing architecture. The protocols themselves function independently of each other and interoperate through the mediation of RIB manager 212, such as through active route selection and redistribution. RIB manager 212 is the primary authority for choosing the routes to be used for forwarding packets. Thus, any attempt to add a route to forwarding information base 220 will traverse through RIB manager 212. An example of this flow is that static routes and direct routes (routes to local IP interfaces) are supplied to RIB Manager 112, not directly to the forwarding information base 120.

In an alternative embodiment, FIG. 2 illustrates a distributed RIB. In conventional dynamic routing systems, the RIB is a central shared resource for the protocols to use to store all their candidate routes and all of the per-protocol attributes for each respective route. In an embodiment of the present invention where the RIB is distributed, only the routes that protocols want considered by the RIB manager 212 for forwarding are selected from the protocol-specific local RIBs (shown as elements 222, 224, 226 and 228 for the various routing protocols) for addition to the central RIB (i.e., the data managed by RIB manager 212). The remainder of each protocol's RIB entries and their associated data are kept in that protocol's local RIB.

By having a distributed RIB, the entries added by a specific protocol typically are deleted or modified only by that specific protocol. Thus, each protocol is able to control what specifically has been transmitted to the central RIB. Thus, once a given protocol makes a change to a route in the central RIB, it does not need to contact the central RIB to determine if that change is still in effect. The distributed RIB architecture also decreases contention for shared data between the protocols and limits the complexity of the interaction between the protocols.

However, the routing protocols do not control which routes are the active routes, i.e., the routes chosen by the RIB manager 212 for use in forwarding packets. But the protocols require information as to which routes are active. RIB manager 212 has the responsibility for choosing active routes. Due to the separation of the central RIB from the protocols, the RIB manager 212 indicates to the protocols whether their routes are active and, moreover, notifies them should this situation change. This is shown in FIG. 2 by the addition of the “active route lookup/notification” element 230 to RIB manager 212.

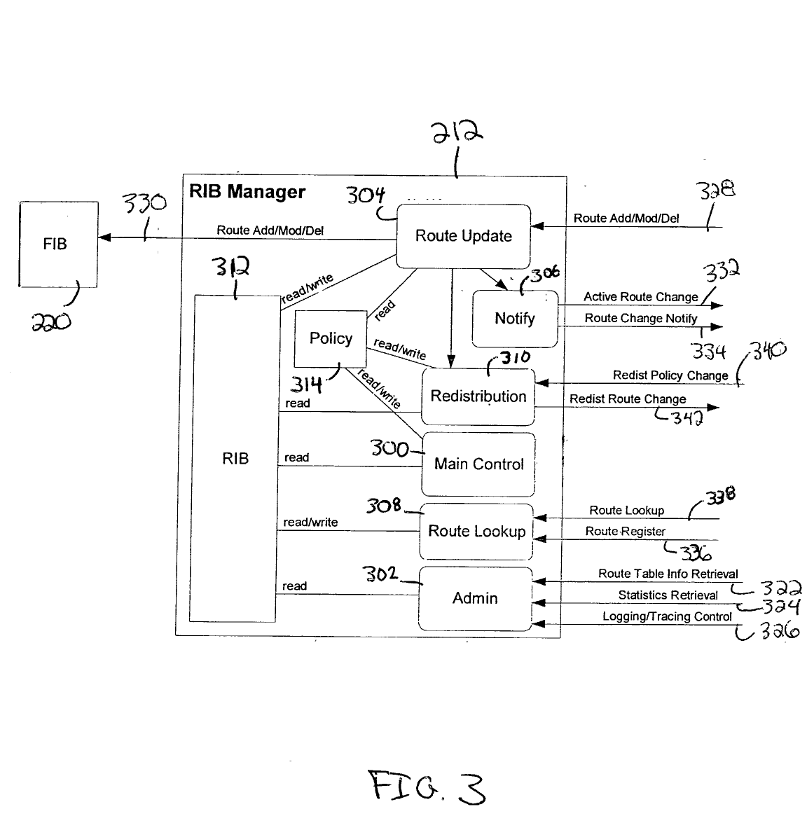

FIG. 3 is a block diagram depicting the function of the RIB manager 212 according to an illustrative embodiment of the present invention. In FIG. 3, the boxes with rounded corners represent the RIB manager processing sub-components, and the boxes with sharp corners represent RIB manager common data. FIG. 3 illustrates some of the primary external interactions related to each sub-component. In one embodiment, the RIB manager 212 utilizes multi-threading capabilities. The RIB manager 212 includes a set of processing sub-components 300, 302, 304, 306, 308 and 310 that represent classes of functions that run within the context of a process thread. These processing sub-components include main control sub-component 300, administrative sub-component 302, route update sub-component 304, notify sub-component 306, route lookup sub-component 308 and redistribution sub-component 310. Illustratively, the functions of the processing sub-components 300, 302, 304, 306, 308 and 310 are performed by a set of application programming interfaces (APIs) that provide access to RIB data 312. The common data in RIB manager 212 includes of the RIB data 312 and policy data 314. FIG. 3 also shows some of the primary interactions between each processing sub-component 304, 310, 306, 300, 308, 302 and these common data stores, i.e. “read” or “read/write”.

The main control sub-component 300 is the main thread for the RIB manager 212. It is responsible for coordinating state within the RIB manager 212 during initialization/shutdown phases. More specifically, the main control sub-component 300 sets internal state variables and utilizes locking mechanisms for controlling access to the RIB data 312 or policy data 314 to prevent functions implemented by other RIB manager sub-components from executing.

The administrative sub-component 302 receives and responds to requests for various types of information pertaining to the RIB manager 212. In one embodiment, the administrative sub-component 302 receives and responds to a request for various types of data contained in the RIB 312, as indicated in FIG. 3 by the arrow labeled “route table info retrieval” 322. Such a request could come, for example, from an element management subsystem (EMS) whose duty is to manage the router configuration of dynamic routing system 200. The information requested and provided can include, for example, any or all of the following: the destination IP address of the route; the protocol that added the route to the RIB 312; the preference value, or administrative distance, of the route; the route type; the status of the route (active or inactive); the age of the route; the cost value that is assigned by the routing protocol for the route; the number of nexthops for the route; the immediate nexthop IP address; and the local IP address. Many additional types of information can be maintained and retrieved from the RIB 312.

In another embodiment, the administrative sub-component 302 receives and responds to a request for various types of statistical information that is maintained by the RIB manager 212, as indicated in FIG. 3 by the arrow labeled “statistics retrieval” 324. The statistical information requested and provided can include, for example, any or all of the following: the current total number of routes in the RIB 312; the current total number of active routes in the RIB 312; the current number of routes in the RIB 312 for a specified routing protocol; the current number of active routes in the RIB 312 for a specified routing protocol; the number of active routes provided to or deleted from forwarding information base 220 since the last statistics reset; the number of route adds, route replacements, or route deletes performed by a specified routing protocol since the last statistics reset; and the number of routes that have been redistributed or unredistributed to a specified routing protocol since the last statistics reset.

In another embodiment, the administrative sub-component 302 receives and responds to tracing and logging control commands, as indicated in FIG. 3 by the arrow labeled “logging/tracing control” 326. Events that can be traced/logged by the RIB manager include, for example, any or all of the following: route updates to the forwarding information base 220, route updates from routing protocols, redistribution interactions, route lookups and registrations from routing protocols, administrative requests, policy configuration interactions, and RIB data access.

Requests for RIB data or operational configuration data from the administrative sub-component 302 could potentially result in large amounts of data being transferred. Therefore, in an illustrative embodiment, the administrative sub-component 302 supports functions that allow information concerning multiple routes in the RIB 312 or multiple configuration elements to be retrieved in a single function call. In a further embodiment, the functions of the administrative sub-component 302 allow the requesting entity to specify how many elements to retrieve at one time so that the amount of buffer space (and, indirectly, processing time) needed to transfer this information can be controlled

The route update sub-component 304 is where active route selection policy is carried out. In order to perform active route selection, RIB manager 212 accepts route updates (adds/modifies/deletes) 328 from each routing protocol. As indicated by arrow 328, the route update can take the form of an addition of a route, a modification of a route or a deletion of a route. Each individual route update is processed according to route selection policy 314 before it is stored in the RIB 312. RIB manager 212 evaluates the route update against any matching routes from different routing protocols, and determines whether an active route change should take place. In an illustrative embodiment of route selection policy, each route update has a route “preference” value (sometimes referred to as “administrative distance”) associated with it, which is used for comparison against matching routes that were learned previously from different routing protocols. The route with the lowest preference value is considered the best and thus becomes the active route. If preference is equal, then the decision falls back to a default hierarchy definition of route preference for each routing protocol to determine which is “best”. The RIB manager 212 sends the active route update (add/modify/delete) 330 to the FIB manager 220.

The RIB route add/modify/delete function 328 allows an instance of BGP 204, OSPF protocol 206, IS-IS protocol 208, MPLS protocol 216, or static/direct route manager 214 to add, replace or delete one or more single path or multipath routes to or from the RIB 312. For MPLS routes, a route represents the ingress end of an MPLS tunnel.

The FIB route add/modify/delete function 330 is used to update (e.g. add, replace, or delete) a single path or multipath route in the forwarding information base 220. In an illustrative embodiment, a route's destination IP address is specified along with information regarding one or more nexthops. If the specified route does not exist in the forwarding information base 220, then the route is added to the forwarding information base 220. If the specified route already exists in the forwarding information base 220, then the existing route's nexthop information in the forwarding information base 220 is overwritten.

In one embodiment of the present invention, if a change is made to an active route, the route update sub-component 304 utilizes policy data 314 to retrieve redistribution policy for determining whether the new active route should be redistributed to any other routing protocols and the prior active route should no longer be redistributed to other routing protocols. If redistribution policy indicates that a route should be redistributed to routing protocols, or indicates that a previously redistributed route should no longer be redistributed, the route is internally queued for processing by the redistribution sub-component 310.

A route change can also result in the need to send out a route change notification to a routing protocol. This can occur if the route change affects an active or inactive route that a routing protocol had previously registered with RIB manager 212 for route change notification. For the BGP protocol 204, this can also occur if a BGP route goes from an inactive state to an active state or vice versa. In either case, the route update sub-component 304 internally queues the route for the notify sub-component 306 to process the route change notification to a routing protocol.

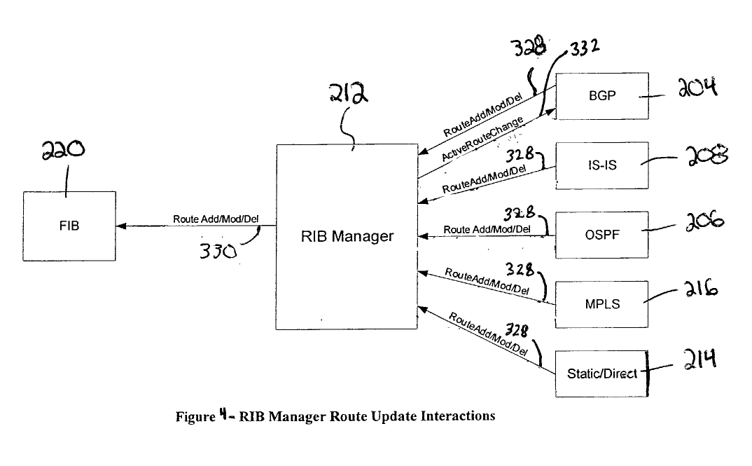

FIG. 4 is a block diagram depicting the flow of information in and out of RIB manager 212 during route update interactions. In order to perform active route selection, RIB manager 212 accepts routing updates (adds/modifies/deletes) 328 from each routing protocol, evaluates the route update against any matching routes from different routing protocols, and determines whether an active route change should take place, as discussed above with respect to FIG. 3. If so, the RIB manager 212 sends the active route update (add/modify/delete) 330 to FIB manager 220. In the specific case that a BGP route stored in RIB 312 changed from active to inactive or vice versa, BGP 204 is notified of the BGP route that was affected. Also, when BGP 204 replaces the active route with a new route definition, RIB manager 212 notifies BGP 204 that the route is still active. This special interaction is indicated in FIGS. 3 and 4 by the arrow labeled “active route change” 332. If another protocol causes a change to an inactive BGP route, RIB manager 212 does not notify BGP 204 of the change. Unless BGP protocol 204 has otherwise registered for notification of changes to inactive routes, BGP protocol 204 is not notified of changes to these routes. The active route change notification 332 is generated by notify sub-component 306 (shown in FIG. 3).

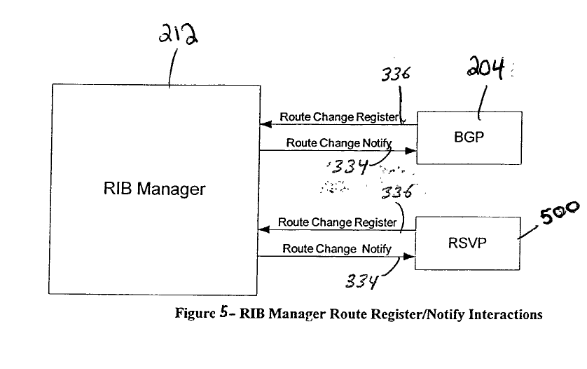

FIG. 5 is a is a block diagram depicting the flow of information in and out of RIB manager 212 during route register/notify interactions. In this example, BGP protocol 204 and RSVP protocol 500 within MPLS protocol 216 each have a route change register output 336 and a route change notify input 334, which are coupled to corresponding inputs and outputs of RIB manager 212. When a routing protocol registers for a route change notification, the protocol sends a registration request to RIB manager 212, which is received by route lookup sub-component 308 (shown in FIG. 3). If a route is located that matches the request, the route is successfully registered for the requesting protocol. Once RIB manager 212 has registered a route for a requesting protocol, notify sub-component 306 (also shown in FIG. 3) sends notifications to that protocol of changes to the registered route, as indicated by arrows 334.

The notify sub-component 306 is driven by an internal queue of routes for route change notification to the routing protocols. The route update sub-component 304 populates this internal queue as a result of processing route updates that change the set of routes in RIB 312 for which the routing protocols have registered for notification. Thus, a primary responsibility of the notify sub-component 306 is to deliver route change notifications to the appropriate routing protocols.

The route update sub-component 304 populates this internal queue with routing information for route change notifications and then signals the notify sub-component 306 by setting the condition variable on which the notify sub-component is waiting. When the notify sub-component 306 is signaled to process the internal queue it processes all elements in the queue. The route update sub-component 304 and the notify sub-component 306 utilize thread locking mechanisms to control access to the internal queue.

When processing an element in the internal queue, the notify sub-component 306 performs one of the following functions, depending on the particular data in the element. If the data indicates that a route change corresponds to a route (either active or inactive) that a routing protocol had registered for notification, the appropriate routing protocol is notified. If the data indicates that a route change caused a BGP route to change from active to inactive, or from inactive to active, BGP 204 is notified of the route's change in status.

Referring back to FIG. 3, route lookup sub-component 308 provides the route lookup function and the register function. For a route lookup, the route lookup sub-component 308 can perform an exact match lookup in the RIB 312 for a given route prefix. Optionally, the particular protocol and protocol instance that may have added the given route prefix can be specified. If the route is found in the RIB 312 and that route was added by the specified protocol instance, its status is returned to the routing protocol that requested the information. Other variables can also be used as criteria for performing a route lookup. In another embodiment, the route lookup sub-component 308 performs a longest match (i.e., “best”) route lookup in the RIB 312 for a given IP address. If the route is found in the RIB 312, the route's IP address and mask, protocol id, protocol instance, cost and nexthop information are returned to the requesting routing protocol.

With respect to the registration function, the route lookup sub-component 308 receives requests from a routing protocol to register for route change notification, as shown by arrow 336 in FIG. 3. If the registered route subsequently changes, the notify sub-component 306 notifies the registering protocol of the change, as indicated by arrow 334 in FIG. 3. The registering protocol can then respond accordingly.

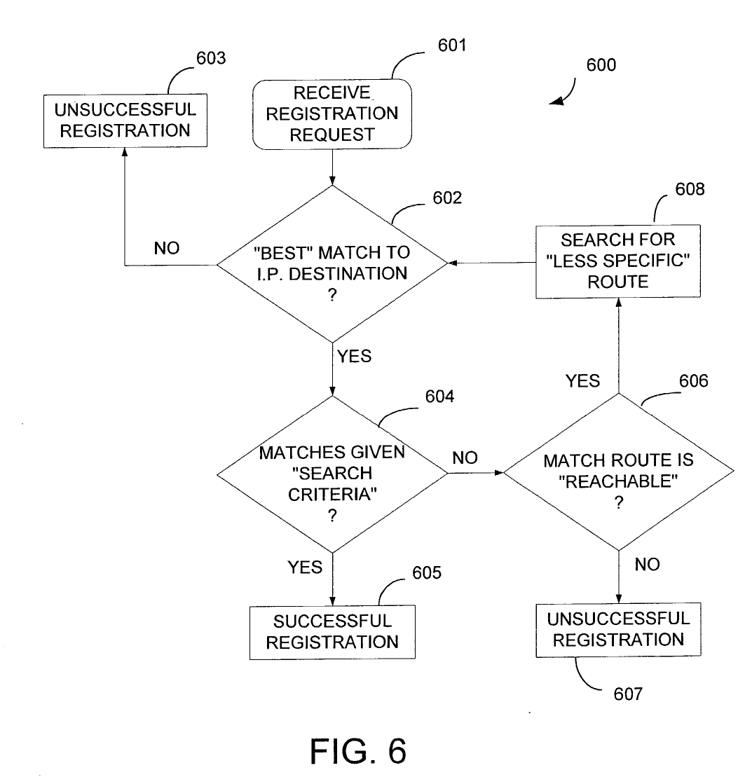

FIG. 6 is a flow chart illustrating a process 600 in which route lookup sub-component 308 handles a registration request from a protocol according to one embodiment of the present invention. At step 601, route lookup sub-component 308 receives a registration request from one of the protocols, such as MPLS protocol 216 in FIG. 3. At step 602, the registration function of route lookup sub-component 308 performs a longest match (“best match”) route lookup using the IP address of the destination indicated in the registration information provided by the registering routing protocol. If no “best match” route is located in RIB 312 (shown in FIG. 3), the registration function ends with an “unsuccessful registration”, at step 603. This status can be returned to the registering routing protocol in one embodiment of the present invention.

If a “best match” route is located in RIB 312, then the registration function compares attributes of that route to any “search criteria” provided by the registering protocol, at step 604. For example, the registering protocol may wish to locate only those routes that were added to RIB 312 by a particular routing protocol or protocol instance. The registering protocol may also specify whether the registration function should consider both active and inactive routes. In one embodiment, the registration function has a default state in which only active routes are considered for registration. Another search criteria can specify whether the registration function should consider “unreachable” routes. Numerous additional search criteria can also be used in alternative embodiments of the present invention. If the registration function locates a route in RIB 312 that matches the specified search criteria, at step 604, the registration function ends with a “successful registration”, at step 605.

A registration is then placed on the matching route. The registration identifies the protocol id, protocol instance, and IP address used for matching. As a result, a routing protocol will receive notification of changes to the “registered” route in the RIB. In one embodiment of the registration function of the present invention, a registration type can be specified, which can be either a static registration or a dynamic registration. If a static registration is indicated, the actual route that matched is returned to the registering protocol within the handle return data, and the registration will not subsequently be moved to a different route. Thus, if a new route is added which is a “better” match to the IP address given by a prior registration, a notification will not result. Also, if the route for which registrations exist is deleted, then notifications will be sent and the registrations will be removed, thereby not requiring an additional step to remove a registration. If, on the other hand, a dynamic registration is specified, the registration can be moved to a different route if a route add/delete occurs which results in a different route which is the best match for the original IP address in a registration.

If the registration function does not locate a route in RIB 312 that matches the specified search criteria, at step 604, the registration function determines whether the specified IP destination is “reachable”, at step 606. If not, the registration function ends with an “unsuccessful registration”, at step 607. If the destination is reachable or if the search criteria specified that unreachable destinations should be considered, then the registration function searches for a “less specific” route at step 608, and then compares any located routes to the search criteria at step 604.

Once a successful registration has been accomplished, notify sub-component 306 notifies the registering protocol if the registered route subsequently changes. Various types of route changes can trigger notification. Some examples include: a) a change in the number of nexthops for a route, b) a change in the set of nexthop interfaces, c) a change in the load balance value for any nexthop, d) a change in the remote IP address for any nexthop, or e) a change in the MPLS label switched path (LSP) ID value for any nexthop. If a static registration is specified, the registering routing protocol is not notified if the change to the route involves a new route being designated the active route. In contrast, if a dynamic registration is specified, the registering routing protocol is notified upon a designation of a new route as the active route, and, the registered routing protocol continues to be notified of changes to the active route after a new route is designated the active route.

A routing protocol can also subsequently remove its registration for notification for changes to a particular route in RIB 312. The information provided by the requesting routing protocol in the request 336 contains a type parameter that indicates either a static or a dynamic “unregistration” is requested. If a static unregistration is specified, an exact match lookup is performed to find the registration, using the route prefix specified, and the registration of that route is removed. If a dynamic unregistration is specified, a longest match (i.e. “best”) route lookup is performed to find the registration, using the given IP address specified and the registration of that route is removed.

Any routing protocol can use the registration function. For example, when BGP 204 needs to add a route using a BGP nexthop value that is not directly connected (as is common with internal Border Gateway Protocol (IBGP) peering), it performs a RIB route lookup of an Interior Gateway Protocol (IGP) route, such as a route provided by OSPF protocol 206, IS-IS protocol 208 or RIP 210. In this way, BGP 204 resolves the BGP nexthop to an immediate nexthop value. BGP 204 then uses the nexthop information from the found IGP route when it adds the BGP route to the RIB 312. Thus, according to an illustrative embodiment of the present invention, BGP 204 can register (as represented by arrow 336 in FIG. 3) the IGP route so as to know if it changes, thereby allowing BGP 204 to ensure that the BGP routes that it adds to RIB 312 are valid. Thus, if a route change in the RIB 312 affects an IGP route with which BGP 204 has registered for notification of a change, RIB manager 212 will explicitly notify BGP 204 of the route change (as represented by arrow 334 in FIG. 3). BGP 204 can then perform an update (i.e. add/modify/delete) 328 to the RIB manager 212 for any affected BGP route in response.

Similarly, MPLS protocol 216 (specifically the RSVP protocol) can also utilize the route registration function provided by the route lookup sub-component 308. For example, RSVP protocol 500 uses this function when establishing “best-effort” MPLS tunnels that originate on the router 110 or transit the router 110. More specifically, RSVP protocol 500 performs a RIB route lookup to find the nexthop for a “best effort” MPLS tunnel. RSVP protocol 500 can then register (as represented by arrow 336 in FIG. 3) for notification from RIB manager 212 when the route used to determine the MPLS tunnel nexthop is no longer following the “best” path. Thus, if a route change in the RIB 312 affects a route with which RSVP protocol 500 has registered for notification of a change, RIB manager 212 will notify RSVP protocol 500 of the route change (as indicated by arrow 334 of FIG. 3). As a result, RSVP protocol 500 can then register/unregister routes to a certain destination with the RIB manager 212 in response. It should be noted that although the registration function is discussed herein with respect to BGP protocol 204 and MPLS protocol 216, the registration function can also be employed by other routing protocols.

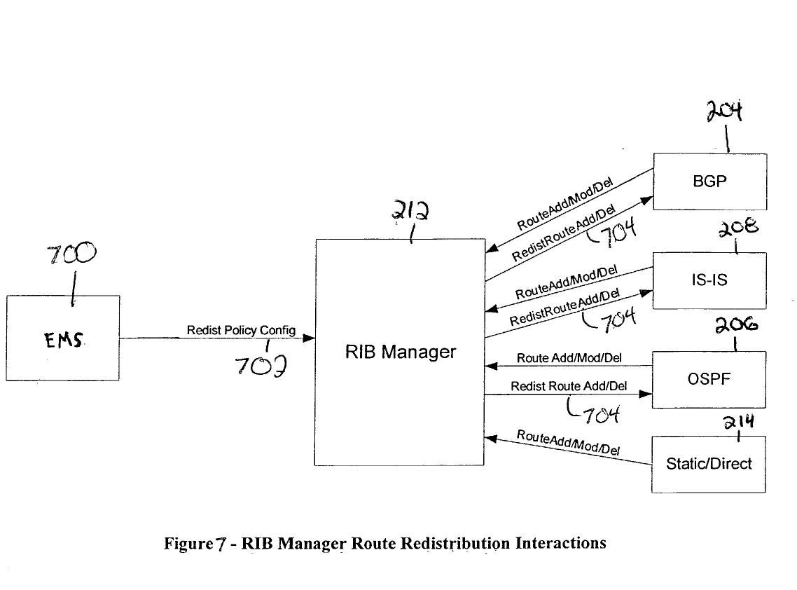

Referring again to FIG. 3, RIB manager 212 also facilitates the redistribution of routing information between routing protocols. FIG. 7 shows the interactions related to route redistribution. RIB manager 212 receives redistribution policy configuration 702 from element management system (EMS) 700. This is also shown in FIG. 3 by arrow 340. Redistribution policy configuration 702 defines the destination protocols, the source routing protocols, the specific sets of routes to be redistributed from one routing protocol to another, and any explicit route attributes that are to be set for the redistributed routes. RIB manager 212 evaluates the redistribution policy against the current set of active routes in the RIB. Then the redistribution sub-component 310 in the RIB manager 212 sends to the appropriate routing protocols route information indicating new routes to be redistributed and/or routes that should no longer be redistributed, as indicated by arrows 342 in FIG. 3 and arrows 704 in FIG. 7. When a policy change notification is received from the EMS 700, the redistribution sub-component 310 traverses all active routes in the RIB 312 to determine if new redistribution notifications need to be sent to any routing protocols.

The redistribution sub-component 310 is driven by an internal queue of routes to be redistributed to routing protocols. The route update sub-component 304 populates this internal queue as a result of processing route updates that result in changes to the set of active routes in the RIB 312. More specifically, the route update sub-component evaluates new active routes against redistribution policy, and if an active route change indicates that a route needs to be redistributed (or “unredistributed”), the route is placed on an internal queue for the redistribution sub-component thread 310 to process. The redistribution sub-component thread 310 is then responsible for redistributing/unredistributing the routes on this internal queue to the appropriate routing protocols.

The functions performed by the various elements of dynamic routing system shown in the preceding figures and discussed above can be implemented in software, hardware, or a combination of both software and hardware. In one embodiment of the present invention, the registration and notify functions are implemented in software instructions that are stored on a computer-readable medium, which are executed by routing application processor 112. The instructions can be stored in memory within RPP 112 or in a computer-readable medium external to RPP 112.

In summary, the RPP 112 improves router scalability, efficiency and reliability by providing a distributed RIB architecture in which each of a plurality of routing protocols has an associated local RIB in addition to the shared central RIB. This distributed RIB architecture reduces the work load of the central RIB and reduces the dependence of each protocol on the central RIB. It also decreases contention for shared data between the protocols and limits the complexity of the interaction between the protocols. Also, the registration function allows a routing protocol to be notified only of changes to routes for which the routing protocol has registered for notification. This conserves RIB manager resources. With respect to BGP, the BGP protocol is notified of changes to routes for which this protocol has registered and for those routes changing between active and inactive states. The BGP is not notified of changes to inactive routes that the BGP has not registered for notification. This further conserves RIB management resources.

It is to be understood that even though numerous characteristics and advantages of various embodiments of the present invention have been set forth in the foregoing description, together with details of the structure and function of various embodiments of the invention, this disclosure is illustrative only, and changes may be made in details, especially in matters of structure and arrangement of parts within the principles of the present invention to the full extent indicated by the broad general meaning of the terms in which the appended claims are expressed. For example, although the RIB management system is described herein with respect to a unicast routing architecture, the RIB management system of the present invention may be employed in other routing architectures, for example, multicast routing architectures, without departing from the scope and spirit of the present invention. Other modifications can also be made.

What is claimed is:

1. A method of managing a routing information base adapted to store information regarding potential data routes within an internetworking device operating in conjunction with a plurality of routing protocols, the method comprising the steps of:
(a) storing a route to be employed for a specified destination in the routing information base; and
(b) notifying a first routing protocol if a change is made to the route stored in the routing information base if the first routing protocol has registered to be notified of a change to that route.

2. The method of claim 1 and further comprising:
(c) storing additional routes for the specified destination in the routing information base; and
(d) withholding notification of the first routing protocol of changes to the additional routes if the first routing protocol has not registered to be notified of changes to the additional routes.

3. The method of claim 1 wherein the first routing protocol comprises a border gateway protocol (BGP) and the method further comprises:
(c) notifying the BGP if a change is made to the route stored in the routing information base if and only if the route is in an active state, the BGP has registered to be notified of a change to that route, or the route has changed between the active state and an inactive state.

4. The method of claim 1 further comprising:
(c) prior to notifying step (b), receiving a registration request from a first routing protocol; and
(d) registering the route with respect to the first routing protocol in response to the registration request, wherein notifying step (b) is performed if and only if the route is registered with respect to the first routing protocol.

5. The method of claim 4 wherein:
step (d) comprises searching the routing information base for the route among a plurality of routes based on a best match route to the specified destination.

6. The method of claim 5 wherein:
step (d) further comprises terminating registration if the route is not located based on the best match route to the specified destination.

7. The method of claim 4 wherein:
step (d) comprises searching the routing information base for the route among a plurality of routes based on search criteria provided by the first routing protocol with the registration request.

8. The method of claim 7 wherein the search criteria specifies a protocol that stored the route in step (a).

9. The method of claim 7 wherein the search criteria specifies whether the plurality of routes to be searched includes inactive routes.

10. The method of claim 7 wherein the search criteria specifies whether the specified destination is required to be reachable by the route.

11. The method of claim 4 wherein the change to the route comprises a change to an attribute of the route.

12. The method of claim 4 wherein the route is an active route and the registration request specifies one of a static registration and a dynamic registration, and wherein if a dynamic registration is specified, a subsequent designation of a new active route results in the registration being transferred from the former active route to the new active route and if a static registration is specified, a subsequent designation of a new active route results in the registration remaining with the former active route

13. The method of claim 12 wherein if a static registration is specified, notification step (b) is not performed if the change comprises a new route being designated the active route, whereas if a dynamic registration is specified, notification step (b) is performed if the change comprises a new route being designated the active route.

14. An internetworking device adapted to operate in conjunction with a plurality of routing protocols, including a first routing protocol, the internetworking device comprising:
a routing information base adapted to store a plurality of routes to a plurality of specified destinations, including a first route to a first destination; and
a routing information base manager coupled to the routing information base and adapted to notify the first routing protocol if a change is made to the first route if the first routing protocol has registered with the routing information base manager for notification of changes to the first route.

15. The internetworking device of claim 14 wherein:
the routing information base stores a plurality of routes, including the first route, to the first destination; and
the routing information base manager is adapted to notify the first routing protocol if a change is made to the first route but not if a change is made to any of the other of the plurality of routes to the first destination, if the first routing protocol has registered for notification of changes to the first route but not to the other of the plurality of routes.

16. The internetworking device of claim 14 wherein the first routing protocol comprises a border gateway protocol (BGP) and wherein:
the routing information base manager is adapted to notify the BGP if a change is made to the first route if and only if the route is in an active state, the BGP has registered to be notified of a change to that route, or the route has changed between the active state and an inactive state.

17. The internetworking device of claim 14 wherein the change to the route comprises a change to an attribute of the route.

18. The internetworking device of claim 14 wherein the routing information base manager comprises:
a registration input from the first routing protocol; and
a route change notification output to the first routing protocol.

19. The internetworking device of claim 18 wherein the routing information base manager comprises means for receiving a registration request from the first routing protocol for the first route on the registration input and registering the first route with respect to the first routing protocol in response to the registration request.

20. The internetworking device of claim 19 wherein the routing information base manager notifies the first routing protocol if a change is made to the first route through the route change notification output if and only if the first route is registered with respect to the first routing protocol.

21. The internetworking device of claim 19 wherein the routing information base manager comprises means for searching the routing information base for the first route among the plurality of routes based on a best match route to the first destination.

22. The internetworking device of claim 19 wherein the routing information base manager comprises means for terminating registration if the first route is not located based on the best match route to the first destination.

23. The internetworking device of claim 19 wherein the routing information base manager comprises means for searching the routing information base for the first route among the plurality of routes based on search criteria provided by the first routing protocol with the registration request.

24. The internetworking device of claim 23 wherein the search criteria specifies a protocol that stored the route in the routing information base.

25. The internetworking device of claim 23 wherein the search criteria specifies whether the routes to be searched includes inactive routes.

26. The internetworking device of claim 23 wherein the search criteria specifies whether first destination is required to be reachable by the first route.

27. A computer-readable medium having instructions stored thereon, which when executed by a processor of an internetworking device that is adapted to operate in conjunction with a plurality of routing protocols perform steps comprising:
(a) storing a route to be employed for a specified destination in the routing information base; and
(b) notifying a first routing protocol if a change is made to the route stored in the routing information base if the first routing protocol has registered to be notified of a change to that route.

28. The computer-readable medium of claim 27 wherein the steps further comprise:
(c) storing additional routes for the specified destination in the routing information base; and
(d) withholding notification of the first routing protocol of changes to the additional routes if the first routing protocol has not registered to be notified of changes to the additional routes.

29. The computer-readable medium of claim 27 wherein the first routing protocol comprises a border gateway protocol (BGP) the BGP is notified if a change is made to the route stored in the routing information base if and only if the route is in an active state, the BGP has registered to be notified of a change to that route, or the route has changed between the active state and an inactive state.

30. The computer-readable medium of claim 27 wherein the steps further comprise:
(c) prior to notifying step (b), receiving a registration request from a first routing protocol; and
(d) registering the route with respect to the first routing protocol in response to the registration request, wherein notifying step (b) is performed if and only if the route is registered with respect to the first routing protocol.

31. The computer-readable medium of claim 30 wherein:
step (d) comprises searching the routing information base for the route among a plurality of routes based on a best match route to the specified destination.

32. The computer-readable medium of claim 30 wherein:
step (d) comprises searching the routing information base for the route among a plurality of routes based on search criteria provided by the first routing protocol with the registration request.

33. The computer-readable medium of claim 27 wherein the change to the route comprises a change to an attribute of the route.

34. An internetwork router comprising:
a routing protocol;
a routing information base coupled to routing protocol for storing information regarding potential data routes to specified destinations; and
routing information base managing means for notifying the routing protocol if a change is made to any of the potential data routes for which the routing protocol has previously registered with the routing information base managing means for notification of a change to those routes.

35. A method of managing a routing information base adapted to store information regarding potential data routes in conjunction with a plurality of routing protocols, including a border gateway protocol (BGP), the method comprising the steps of:
(a) storing a BGP route for a specified destination in the routing information base, wherein the BGP route has either an active state or an inactive state; and
(b) notifying the BGP of a change to the BGP route if the change results in the BGP route switching between the active and inactive states and withholding notification of the BGP if the change results in the BGP route remaining in the inactive state.

36. An internetwork router comprising:
a border gateway protocol (BGP);
a routing information base coupled to BGP for storing information regarding a BGP data route to a specified destination, wherein the BGP data route has either an active state or an inactive state; and
routing information base managing means for notifying the BGP of a change to the BGP data route if the change results in the BGP data route switching between the active and inactive states and withholding notification of the BGP if the change results in the BGP data route remaining in the inactive state.
